(19) United States
(12) Patent Application Publication
(10) Pub. No.: US 2011/0194982 A1
(43) Pub. Date: Aug. 11, 2011

(54) AIR CLEANING FILTER COMPRISING PROTEOLYTIC ENZYME AND PROCESS FOR PRODUCING THE SAME

(75) Inventor: Sung Hwa Lee, Gyeongsangnam-do (KR)

(73) Assignee: LG Electronics Inc., Seoul (KR)

(21) Appl. No.: 13/062,895

(22) PCT Filed: Dec. 5, 2008
(86) PCT No.: PCT/KR08/07186

§ 371 Date: Apr. 26, 2011

(30) Foreign Application Priority Data
Sep. 10, 2008 (KR) 10-2008-0089252

(51) Int. Cl. B01J 19/00; B05D 5/00; B05D 3/00

(52) U.S. Cl. 422/120; 427/244

(57) ABSTRACT

The present invention relates to an air cleaning filter having a carrier with a coat of a proteolytic enzyme applied thereto, and a method for manufacturing the same.

### TECHNICAL FIELD

The present invention relates to air cleaning filters. More specifically, the present invention relates to an air cleaning filter having a carrier with a coat of a proteolytic enzyme applied thereto for effective removing and decomposing an allergen, such as house dust mites, from the air, and a method for manufacturing the same.

### BACKGROUND ART

It is a recent trend that a number of people suffering from allergic diseases, such as atopic dermatitis, allergic rhinitis, bronchial asthma, and so on, keep increasing from influences of environmental pollution. The allergen causes the allergic diseases, of which number of kinds, even by a presently identified number, reaches to about 200. As the allergen, there are the house dust mites, pollen, spore, fungus, and so on typically, of which number is increasing day by day. As the allergen enters into a human body, various allergic symptoms appear. Therefore, in order to prevent suffering from the various allergic diseases, such as the atopic dermatitis, in advance, it is required to maintain room air clean always so that the allergen can not inhabit.

### DISCLOSURE OF INVENTION

### Technical Problem

To solve the problems, an object of the present invention is to provide an air cleaning filter which uses a proteolytic enzyme for effectively and continuously removing and decomposing an allergen in the air, specifically, allergen of house dust mites.

Another object of the present invention is to provide a method for manufacturing an air cleaning filter which has a carrier with a coat of a proteolytic enzyme applied thereto for effectively and continuously removing and decomposing an allergen in the air, specifically, allergen such as house dust mites.

### Technical Solution

To achieve these objects and other advantages and in accordance with the purpose of the invention, as embodied and broadly described herein, an air cleaning filter including a carrier having a proteolytic enzyme applied thereto to remove and decompose an allergen.

In another aspect of the present invention, a method for manufacturing an air cleaning filter includes the step of coating and setting a proteolytic enzyme on a carrier of an air cleaning filter. Alternatively, a method for manufacturing an air cleaning filter includes the steps of coating a coating solution consisting of a binder, a proteolytic enzyme, apatite, water and alcohol on a surface of a carrier of the air cleaning filter, and drying the carrier coated thus.

As a material of the carrier of the air cleaning filter of the present invention, any one can be used without particular limitation in view of kind, shape, size, and a fabrication method thereof as far as the material has a function of carrier of an air cleaning filter. For an example, glass fibers, ion exchange fibers, cellulose fibers, asbestos fibers, various organic fibers and inorganic fibers, deodorizing activated carbon, activated carbon fibers, porous ceramic, metal, such as zinc, copper, aluminum, or plastic can be used. The materials may be used according to properties of the materials suitable to purposes in a variety of ways.

A type of the carrier may be varied without particular limitation according to the air cleaning filter to which the carrier is applied, such as a type of honeycomb, particle, net, filter paper, puff, mesh, plate, zebra, or foam.

The air cleaning filter having the carrier is applicable to an activated carbon deodorizing filter used for home appliances, such as a refrigerator and an air conditioner, HEPA filter, and air cleaning filter for cars, or may be used in parallel therewith.

The proteolytic enzyme may be Bacillus licheniformis protease, Bacillus polymixa protease, chymotrypsin, Ficin, Papain, Proteinase K, Streptomyces protease, Subtilisin A, trypsin or so on without kinds thereof. Or, biomass thereof may be extracted for use, or proteolytic enzyme may be purchased if commercially available, and any state of the proteolytic enzyme can be used. Subtilisin A is preferable.

A method for manufacturing an air cleaning filter includes the step of coating and setting a proteolytic enzyme on a carrier of an air cleaning filter.

Alternatively, a method for manufacturing an air cleaning filter includes the steps of coating a carrier with a coating solution comprising a proteolytic enzyme, a binder selected from the group consisting of silicon modified acrylic resin, urethane resin, acrylic resin and silicon resin, apatite, water and alcohol by spraying it on a carrier of the air cleaning filter or dipping it into the coating solution.

That is, the air cleaning filter having a carrier with a proteolytic enzyme applied thereto is fabricated by coating the proteolytic enzyme to the carrier directly, or preparing a coating solution including the proteolytic enzyme at first, and coating the coating solution on the carrier by dipping or spraying. The step of coating and setting the proteolytic enzyme on a carrier of an air cleaning filter can be carried out by general methods in the art. Depending on cases, it is required to change a state of the carrier to a form suitable for coating the proteolytic enzyme. Chemical or physical method may be used for setting the proteolytic enzyme on the carrier of the air cleaning filter of the present invention.

In another method for manufacturing an air cleaning filter, in which a proteolytic enzyme is coated on the carrier, a coating solution containing a proteolytic enzyme is prepared by mixing the proteolytic enzyme with a binder such as silicon modified acrylic resin, urethane resin, acrylic resin and silicon resin, apatite, water and alcohol, and the coating solution prepared thus is coated on a surface of the carrier of the air cleaning filter by spraying or dipping. In this instance, a method for preparing the coating solution has no particular limitation as far as a binder and apatite can be mixed together enough to coat a proteolytic enzyme to a surface of the carrier. In view of miscibility and applicability, it is preferable that the coating solution consists of 0.01˜1 wt % of the proteolytic enzyme, 0.1˜0.5 wt % of the binder, 2˜10 wt % of the apatite, and balance of water and alcohol. In this instance, the water in the coating solution is 50˜90 wt % of total solvent, and the alcohol in the coating solution is 10˜50 wt % of total solvent.

The alcohol used for the coating solution is alcohol having a low grade alkyl group, and preferably, absolute ethanol, or isopropyl alcohol.

In the meantime, before coating the carrier with the proteolytic enzyme, the carrier to be used may be washed with appropriate washing water, or the carrier washed thus may be dried by heat treatment or the like. Depending on cases, it is preferable that the carrier of metal or the like may be subjected to removal of oil stuck to a surface of the carrier during a fabrication process or storage. In a case the carrier is dried, a drying time period and a drying temperature can be varied with shape, kind, size, and so on of the carrier. Moreover, a drying step may be included to the method for manufacturing an air cleaning filter of the present invention after the proteolytic enzyme is coated on the carrier.

The carrier may be cut to a required size for use in an air cleaning unit. Moreover, the carrier may be used in the same products individually, or in parallel with a related art air cleaning filter, or deodorizing filter. Thus, the air cleaning filter of the present invention can be used in various domestic and industrial air cleaning units which require the air cleaning filter, and cars, refrigerators, air conditioners, and other home appliances, extensively.

### ADVANTAGEOUS EFFECTS

The air cleaning filter of the present invention having the proteolytic enzyme applied thereto can make continuous removing and decomposing of allergen in the air, particularly, allergen of house dust mites.

### BRIEF DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 illustrates a graph showing amounts of remained allergen from house dust mites on a carrier having Subtilisin A (SA), Bacillus licheniformis protease (SI) and Bacillus polymyxa proteinase K (PK) coated thereon, respectively.

FIG. 2 illustrates a graph showing amounts of remained allergen from dog fur on carriers having Subtilisin A (SA) of three different concentrations coated thereon, respectively.

### BEST MODE FOR CARRYING OUT THE INVENTION

Reference will now be made in detail to the specific embodiments of the present invention, examples of which are illustrated in the accompanying drawings. However, the present invention will not be limited by theses embodiments.

### Embodiment

1. Preparation of a Coating Solution

Proteolytic enzymes of Subtilisin A (called as SA), Bacillus licheniformis protease (called as SI) and Bacillus polymyxa proteinase K (called as PK) are provided, respectively.

In addition to this, 0.3 parts by weight of silicon resin obtained from tetramethyl orthosilicate, methyl tri-methoxysilane, and 3-glycidoxy prophylmethoxysilane is added to a 100 ml aqueous solution having isopropyl alcohol and distilled water mixed therein at a ratio of 1:9, and agitated for about 60 minutes at 1000 rpm to obtain a mixture. Then, 5 parts by weight of apatite is added to the mixture, and agitated for 60 minutes at 1500 rpm. Then, in order to make pH of a mixture obtained thus to be 7˜9, triethylamine is added to the mixture. 0.1 parts by weight of each of above proteolytic enzymes is added to the mixture to obtain a coating solution 1 (a coating solution containing subtilisin A), a coating solution 2 (a coating solution containing Bacillus licheniformis protease) and a coating solution 3 (a coating solution containing Bacillus polymyxa proteinase K), respectively.

2. Fabrication of an Air Cleaning Carrier Having a Proteolytic Enzyme Coated Thereto.

The coating solutions 1˜3 prepared thus are sprayed to zebra patterned electrostatic non woven fabric at a rate of 400˜700 g/m² up to 1000 ppm to obtain air cleaning carriers 1˜3 each having a coat of the proteolytic enzyme applied thereto, respectively.

Also, the coating solution 1 prepared thus is sprayed to zebra patterned electrostatic non woven fabric up to 250 ppm, 500 ppm, and 1000 ppm to obtain air cleaning carriers 4˜6 each having a coat of the proteolytic enzyme applied thereto, respectively.

3. Exemplary Experiments

In order to measure an allergen removal and peptizing capability of each of the air cleaning carrier 1˜3 obtained thus, mite allergen (Der p 1) having protein extracted from mite culture fluid (1.1 mg Dermatophagoides pteronyssinus secretion allergen/1.0 mg protein) is dissolved in phosphate-buffered solution (pH 7.5) up to 0.1 mg/ml, and coated to the air cleaning carriers 1˜3 with a pipette at 0.04 ml/cm². After the carriers coated thus are left in a container having saturated NaCl solution filled therein for 24 hours at a humidity 80% and a temperature 25°, the carriers are extracted with 0.8 ml phosphate-buffered solution (50 mM, pH 7.5, phenylmethlysulfonylfluoride PSMF) for 10 minutes at a room temperature, respectively.

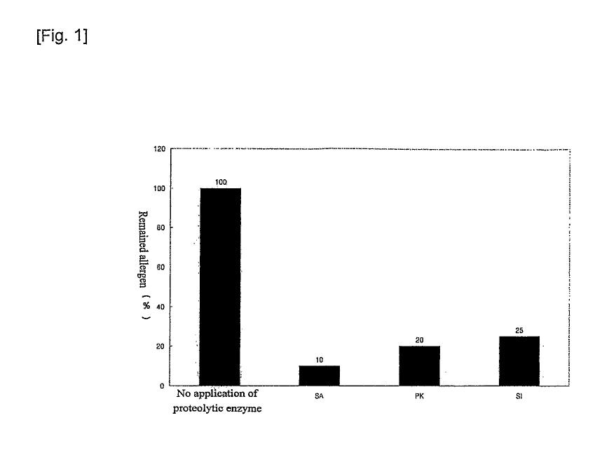

Then, an ELSA analysis is made according to a general method, to obtain a result as shown in FIG. 1.

Also, in order to measure an allergen removal and peptizing capability of each of the air cleaning carriers 4˜6 obtained thus, dog allergen (Can f 1) having protein extracted from dog fur (7.1 mg Canis familiaris secretion allergen/1.0 mg protein) is dissolved in phosphate-buffered solution (pH 7.5) up to 0.1 mg/ml, and coated to the air cleaning carriers 1˜3 with a pipette at 0.04 ml/cm². After the carriers coated thus are left in a container having saturated NaCl solution filled therein for 24 hours at a humidity 80% and a temperature 25°, the carriers are extracted with 0.8 ml phosphate-buffered solution (50 mM, pH 7.5, phenylmethlysulfonylfluoride PMSF) for 10 minutes at a room temperature, respectively.

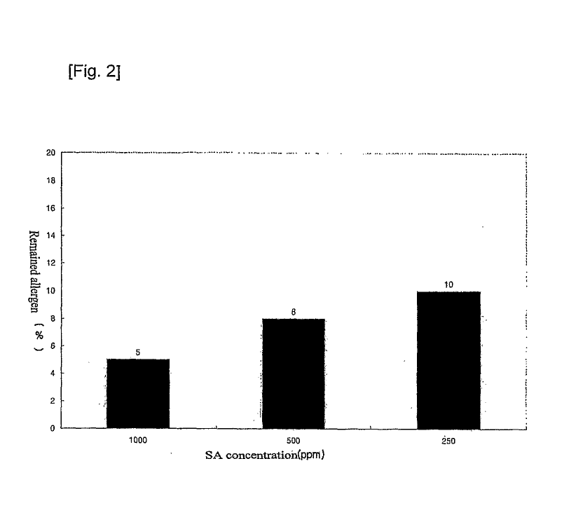

Then, an ELSA analysis is made according to a general method, to obtain a result as shown in FIG. 2.

From the results of FIGS. 1 and 2, it can be determined that the air cleaning filter having the carrier with a proteolytic enzyme applied thereto of the present invention can remove and decompose an allergen effectively and continuously compared to a carrier without the proteolytic enzyme applied thereto.

### INDUSTRIAL APPLICABILITY

The present invention has an industrial applicability.

Thus, the application of a coating of the proteolytic enzyme to the carrier of the air cleaning filter of the present invention enables to improve an allergen removal capability, significantly.

1. An air cleaning filter for removing and decomposing an allergen, wherein proteolytic enzyme is coated onto a carrier, and the proteolytic enzyme is one selected from the group consisting of Bacillus licheniformis protease, Bacillus polymixa protease, chymotrypsin, Ficin, Papain, Proteinase K, Streptomyces proteinase, Subtilisin A and Trypsin.

2. The air cleaning filter according to claim 1, wherein the carrier is one selected from the group consisting of glass fibers, ion exchange fibers, cellulose fibers, asbestos fibers, organic fibers and inorganic fibers.

3. The air cleaning filter according to claim 1, wherein the carrier is a metal or a plastic.

4. The air cleaning filter according to claim 1, wherein the carrier has a honeycomb, particle, net, filter paper, puff, mesh, plate, zebra or foam shape.

5. The air cleaning filter according to claim 1, wherein the carrier is an activated carbon deodorizing filter.

6. The air cleaning filter according to claim 1, wherein the proteolytic enzyme is Subtilisin A.

7. The air cleaning filter according to claim 1, wherein the proteolytic enzyme is Bacillus licheniformis protease.

8. The air cleaning filter according to claim 1, wherein the proteolytic enzyme is proteinase K.

9. The air cleaning filter according to claim 1, wherein the allergen is house dust mites.

10. A method for manufacturing an air cleaning filter according to claim 1 comprising:
coating and setting a proteolytic enzyme onto a carrier of an air cleaning filter, wherein the proteolytic enzyme is one selected from the group consisting of Bacillus licheniformis protease, Bacillus polymixa protease, chymotrypsin, Ficin, Papain, Proteinase K, Streptomyces proteinase, Subtilisin A and Trypsin.

11. A method for manufacturing an air cleaning filter according to claim 1 comprising:
coating a surface of a carrier with a coating solution comprising; a binder selected from the group consisting of silicon-modified acrylic resin, urethane resin, acrylic resin and silicon resin, a proteolytic enzyme, an apatite, water and alcohol; and
drying the coated carrier,
wherein the coating step is conducted by spraying or dipping and the proteolytic enzyme is one selected from the group consisting of Bacillus liclieniforrnis protease, Bacillus polymixa protease, chymotrypsin, Ficin, Papain, Proteinase K, Streptomyces proteinase, Subtilisin A and Trypsin.
